(19) United States
(12) Patent Application Publication
(10) Pub. No.: US 2009/0151519 A1
(43) Pub. Date: Jun. 18, 2009

(54) DUAL SOCKET FOR FAST PACE ASSEMBLY ENVIRONMENT

(76) Inventor: Sylvanus I. Monyem, Miamisburg, OH (US)

Correspondence Address: Harness Dickey & Pierce, P.L.C., P.O. Box 828, Bloomfield Hills, MI, 48303, US

(21) Appl. No.: 11/956,974

(22) Filed: Dec. 14, 2007

(51) Int. Cl. B25B 13/06

(52) U.S. Cl. 81/124.4

(57) ABSTRACT

A tool assembly includes an outer tool having a socket adapted to drivingly engage an outer circumferential surface of a first fastener. An inner tool is positioned within the outer tool. The inner tool is fixed to the outer tool and includes a driver adapted to drivingly engage a second fastener. The driver is axially offset from a distal end of the outer tool such that the second fastener is positioned within the socket when engaged by the driver.

### FIELD

The present disclosure generally relates to a tool for assembling machines. More particularly, a dual socket for drivingly engaging two different fasteners is disclosed.

### BACKGROUND

High speed assembly of machines such as engines, transmissions and other vehicle components has been attempted through the use of work cells and assembly lines at various manufacturing and assembly plants. Based on the complexity and variety of the many components used within a vehicle, a wide variety of fasteners may be used to interconnect the various parts to one another to form a vehicle. Various types and sizes of fasteners often include one or more ends that may be selectively driven by a tool. Depending on the size and the type of the fastener, the driven end may include any number of sizes and shapes. Accordingly, the vehicle assembly plant is typically equipped with a large number of tools adapted to drivingly engage the driven end of the various fasteners.

To maximize the throughput of a given assembly line, a number of assembly workers or robots may be spaced apart from one another along portions of the assembly line or work cell. Each assembly worker may be responsible for more than one assembly task at his or her given station. Many times, the tasks to be performed by a given assembler require tightening fasteners having different driven end configurations. As such, the assembly worker may be required to change the tool coupled to a tool driver or utilize multiple tool drivers equipped with multiple tools located within one assembly station. The cost of assembling the machine may be adversely affected by an increase in the time required for the assembler to complete the given task due to requiring a tool change on a given tool driver. Furthermore, the cost and packaging associated with equipping multiple workstations with multiple tool drivers may become burdensome.

### SUMMARY

A tool assembly includes an outer tool having a socket adapted to drivingly engage an outer circumferential surface of a first fastener. An inner tool is positioned within the outer tool. The inner tool is fixed to the outer tool and includes a driver adapted to drivingly engage a second fastener. The driver is axially offset from a distal end of the outer tool such that the second fastener is positioned within the socket when engaged by the driver.

In another form, a tool assembly to selectively drive first and second fasteners includes a first tool and a second tool. The first tool includes a first end with a bore and a second end. A portion of the bore is shaped as a socket and adapted to drivingly engage the first fastener. The second tool has first and second ends positioned within the bore and is fixed for rotation with the first tool. The first end of the second tool is offset from the first end of the first tool and is adapted to drivingly engage the second fastener. One of the first and second tools has a drive recess positioned at its second end.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a top view of a dual tool assembly constructed in accordance with the teachings of the present disclosure;

FIG. 2 is a cross-sectional side view of the dual tool assembly depicted in FIG. 1;

FIG. 3 is a top view of another dual tool assembly;

FIG. 4 is a cross-sectional side view of the dual tool assembly depicted in FIG. 3;

FIG. 5 is a top view of another dual tool assembly;

FIG. 6 is a cross-sectional side view of the dual tool assembly depicted in FIG. 5;

FIG. 7 is a cross-sectional side view of the dual tool assembly shown in FIGS. 5 and 6 engaged by a driving tool and drivingly engaging a first fastener; and

FIG. 8 is a cross-sectional side view of the dual tool assembly shown in FIGS. 5 and 6 engaged by a driving tool and drivingly engaging a second fastener.

### DETAILED DESCRIPTION

The following description is merely exemplary in nature and is not intended to limit the present disclosure, application, or uses. It should be understood that throughout the drawings, corresponding reference numerals indicate like or corresponding parts and features.

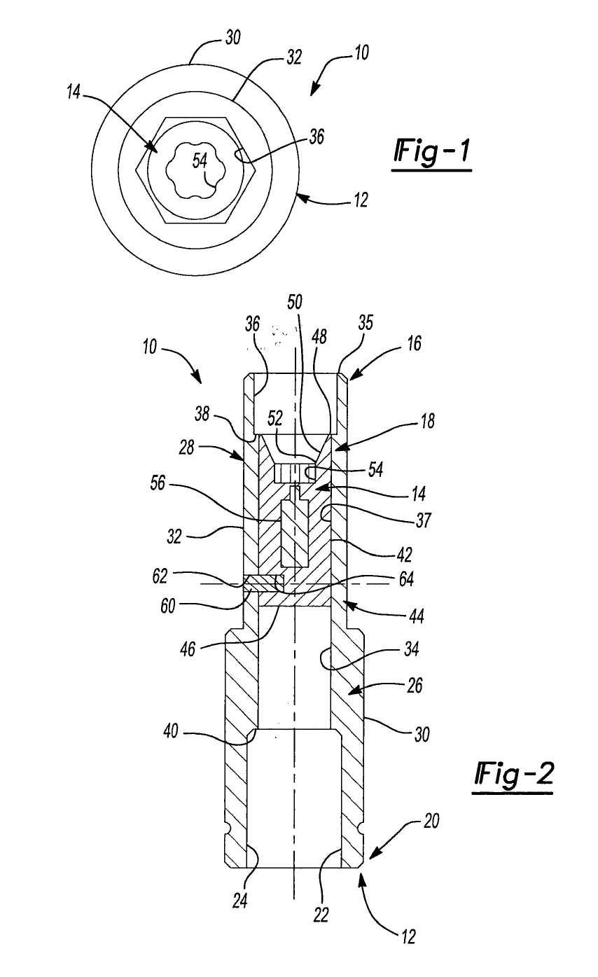

FIGS. 1 and 2 depict a dual tool assembly identified at reference numeral 10. Dual tool assembly 10 includes a first or outer tool 12 drivingly connected to a second or inner tool 14. In the example depicted in FIGS. 1 and 2, outer tool 12 includes a first end 16 configured to drivingly engage a hexagonally-shaped head of a first fastener, such as a cap screw 17 shown in FIG. 7. Inner tool 14 includes a first end 18 configured to drivingly engage a second fastener, such as a screw or stud 19 shown in FIG. 8. It should be appreciated that the shape of the fasteners to be driven and the corresponding shape of the first ends of outer tool 12 and inner tool 14 shown in the Figures are merely exemplary and that dual tool assembly 10 may be adapted to engage different fasteners having other driven end shapes. As will be described in greater detail hereinafter, it is also contemplated that the first end 18 of inner tool 14 may be configured as a male member shaped to drivingly engage a fastener having a recess or female socket formed on its driven end.

Outer tool 12 includes a second end 20 including a drive recess 22 formed therein. Drive recess 22 may be shaped as a square opening having side walls 24 spaced apart a predetermined distance to receive an end of a driving tool 25 (FIGS. 7 & 8). Typically, drive recesses are manufactured in one of a few standard sizes to reduce tool proliferation while maintaining an ability to transfer a desired quantity of torque. For example, common drive recesses may be sized as ⅜″, ½″ or ¾″ squares. However, it should be appreciated that a drive recess may have a different size or shape without departing from the scope of the present disclosure.

Drive recess 22 partially extends into a first body portion 26 of outer tool 12. A second body portion 28 extends from and is integrally formed with first body portion 26. First body portion 26 includes a substantially cylindrical outer wall 30 defining a first diameter. Second body portion 28 includes a substantially cylindrical outer surface 32 having an outer diameter less than the first diameter. A passage 34 extends from first end 16 through second body portion 28 and first body portion 26 in communication with drive recess 22. It may be beneficial for manufacturing purposes to extend passage 34 into communication with drive recess 22 but such a configuration is not necessary. On the contrary, passage 34 may be formed as a blind bore extending inwardly from an end face 35 formed on first end 16. If a blind bore condition exists, drive recess 22 is also formed as a blind bore.

A distal portion of passage 34 includes a socket or shaped recess 36 formed in first end 16 of outer tool 12 and defined by the outer wall surrounding shaped recess 36. An adjacent portion 37 of passage 34 is substantially cylindrically-shaped. Shaped recess 36 is sized and shaped to drivingly engage the first fastener having a similarly sized and shaped external surface. At the intersection of recess 36 and portion 37, a land 38 is formed. Land 38 of inner tool 14 may limit the distance a head of the first fastener, such as a cap screw may enter passage 34. Alternatively, the distal end of inner tool 14 may limit the axial extent the first fastener may enter recess 36. A land 40 is formed at the intersection of drive recess 22 and passage 34.

Inner tool 14 includes a substantially cylindrically-shaped outer surface 42 sized to be received within passage 34. A second end 44 of inner tool 14 includes a second end face 46. First end 18 includes a first end face 48. An inner tool drive recess 50 inwardly extends from first end face 48. Drive recess 50 includes a tapered wall portion 52 and a female socket portion 54. In the example depicted in FIGS. 1 and 2, female socket portion 54 is defined by a driver wall having a hexalobular driving feature sold under the trademark TORX®. Hexalobular internal driving features may be defined by ISO 10664. Each of recess 36, tapered wall portion 52 and female socket portion 54 are axially aligned for rotation about a common axis.

Optionally, inner tool 14 may be equipped with an embedded magnet 56. Magnet 56 is operable to temporarily couple the fastener to dual tool assembly 10. As such, an operator may temporarily couple a fastener to dual tool assembly 10 by positioning the fastener within inner tool drive recess 50 or outer tool recess 36. Once the fastener is driven by dual tool assembly 10, the tool and the fastener are disconnected by applying a relatively low separation force.

Inner tool 14 is positioned within passage 34 as previously described and fixed to outer tool 12. Any number of fastening methods may be used including interconnecting outer tool 12 with inner tool 14 with a pin 60 positioned within an aperture 62 transversely extending from outer surface 32 into passage 34. Pin 60 also extends into a blind bore 64 formed in inner tool 14. Blind bore 64 is aligned with aperture 62 to receive pin 60 and restrict movement of inner tool 14 relative to outer tool 12.

Alternatively, inner tool 14 may be welded to outer tool 12. A weld may interconnect second end face 46 with second body portion 28. In a different arrangement, aperture 62 may be formed in outer tool 12 while blind bore 64 is not formed in inner tool 14. A weld may be positioned within aperture 62 to weld outer surface 32 of inner tool 14 to outer tool 12. In yet another attachment alternative, a set screw may be threadingly engaged with outer tool 12 and rotated to apply a force against inner tool 14 to restrict relative movement between outer tool 12 and inner tool 14. It should be appreciated that other methods of fixing inner tool 14 to outer tool 12 such as adhesive bonding, riveting, threaded fastening, pinning and mechanical interlocking are contemplated as being within the scope of the present disclosure. For example, outer surface 42 of inner tool 14 may include a shape other than a cylinder to mate with a corresponding shape of passage 34 such that a keyed arrangement exists to restrict inner tool 14 from rotating relative to outer tool 12.

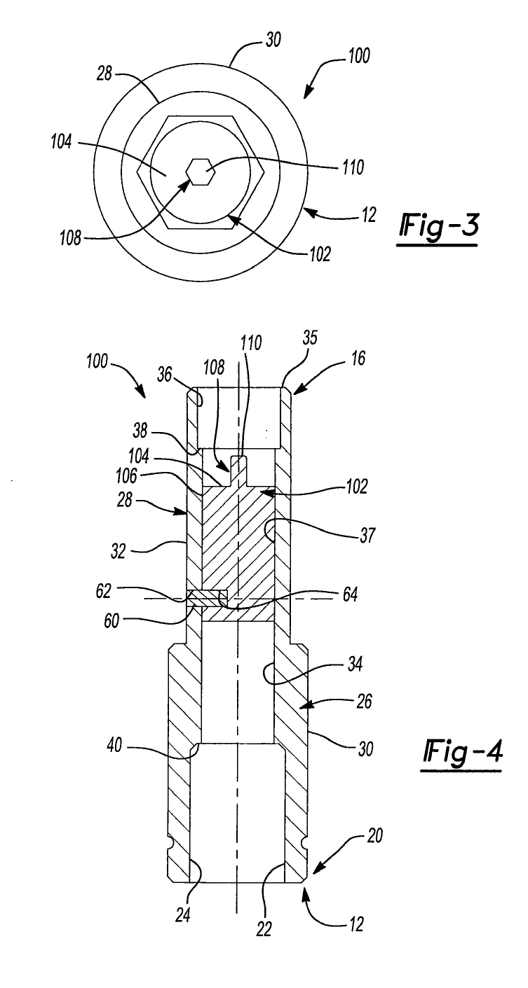

FIGS. 3 and 4 depict another dual tool assembly 100. Dual tool assembly 100 is substantially similar to dual tool assembly 10. As such, like elements will retain their previously introduced reference numerals. In particular, outer tool 12 is substantially the same component within dual tool assembly 10 and dual tool assembly 100. Dual tool assembly 100 includes an inner tool 102 having a body portion 104 with an outer cylindrical surface 106 sized to be received within passage 34. A male driver 108 extends from and is integrally formed with body portion 104. Male driver 108 includes an external profile sized and shaped to mate with a similarly sized and shaped recess formed within a fastener to be driven. Exemplary shapes include a polygonal profile formed with substantially flat surfaces, a Philips head, a square, a rectangle, a straight screwdriver blade, and a hexalobular head shape, among others. A first end face 110 is offset from first end face 35 of outer tool 12. As such, recess 36 extends deeply enough to receive at least a portion of the head of the first fastener to be driven.

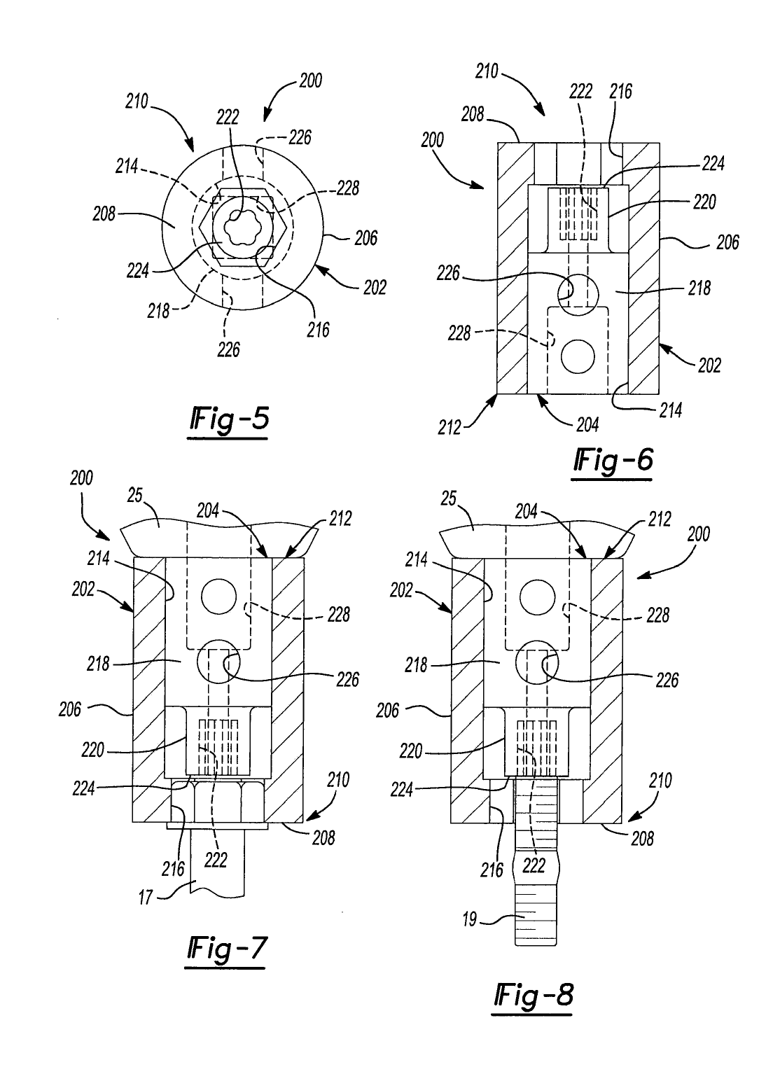

Another dual tool assembly 200 is depicted in FIGS. 5 and 6. Dual tool assembly 200 includes an outer tool 202 in receipt of an inner tool 204. Outer tool 202 has a substantially cylindrical outer surface 206, an end face 208 positioned at a first end 210 and a second end 212. A substantially cylindrically-shaped counterbore 214 extends inwardly from second end 212. A socket or shaped recess 216 extends inwardly from end face 208 in communication with counterbore 214. As previously described, shaped recess 216 is sized and shaped to drivingly engage first fastener 17.

Inner tool 204 includes a substantially cylindrically-shaped body 218 positioned within counterbore 214. A reduced diameter head portion 220 axially extends from cylindrically-shaped body 218. Head portion 220 includes a female socket portion 222 sized and shaped to engage second fastener 19. An end face 224 of inner tool 204 is offset from end face 208 to allow a head of the first fastener to enter dual tool assembly 200 without being impeded by inner tool 204. Each of inner tool 204 and outer tool 202 include aligned apertures 226 in receipt of a dowel, a pin or a weld (not shown). An opposite end of inner tool 204 includes a drive recess 228 adapted to be driven by a power tool.

From the previous description of dual tool assemblies 10, 100 and 200, it should be appreciated that the throughput of a given machine assembly station may be increased by using one of the dual tool assemblies previously described. Furthermore, it should be noted that various dual tool assemblies may be constructed to perform specific tasks at an individual work station. For example, one dual tool assembly may include an outer tool having a 17 mm 12 point socket constructed in combination with an inner tool having a TORX® E6 socket. Alternatively, if a socket head cap screw is to be driven by the inner tool, a male driver having a TORX® T10 size and shape may be provided. As such, task specific dual tool assemblies may be provided to individual assembly workers to reduce the time required to change tools during a machine assembly process. To perform the fastener driving tasks repeatedly over time, each of the inner and outer tools may be constructed, for example, from SAE 4140 steel hardened to a Rockwell C range of 50-52.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

1. A tool assembly comprising:
an outer tool having a distal end and a wall defining a socket adapted to drivingly engage an outer circumferential surface of a first fastener; and
an inner tool positioned within the outer tool, the inner tool being fixed to the outer tool and including a driver adapted to drivingly engage a second fastener, the driver being axially offset from the distal end of the outer tool such that the second fastener is positioned within the socket when engaged by the driver, the inner tool including a tapered surface extending axially between a proximal end of the outer tool and the driver to guide the second fastener into engagement with the driver.

2. The tool assembly of claim 1 wherein the driver is axially aligned with the socket for rotation about a common axis.

3. The tool assembly of claim 2 wherein the driver has a driver wall defining a female socket adapted to drivingly engage an outer circumferential surface of the second fastener.

4. The tool assembly of claim 3 wherein the tapered surface is axially aligned with the female socket to guide the second fastener into engagement with the female socket.

5. The tool assembly of claim 4 further including a pin interconnecting the inner and outer tools and extending substantially perpendicular to the common axis of rotation.

6.-7. (canceled)

8. The tool assembly of claim 1 wherein the inner tool includes a drive recess opposite the driver.

9. The tool assembly of claim 1 wherein the outer tool includes a drive recess opposite the socket.

10. A tool assembly to selectively drive first and second fasteners, the tool assembly comprising:
a first tool including a first end with a wall defining a bore and a second end, a portion of the bore being shaped as a socket and adapted to drivingly engage the first fastener; and
a second tool having first and second ends positioned within the bore and being fixed for rotation with the first tool, the first end of the second tool being offset from the first end of the first tool and adapted to drivingly engage the second fasteners the second tool including a driving portion and a tapered surface extending axially from the first end of the second tool toward the driving portion to guide the second fastener into engagement with the driving portion, one of the first and second tools having a drive recess positioned at its second end.

11. The tool assembly of claim 10 wherein the driving portion is shaped as a female socket.

12. The tool assembly of claim 11 wherein the first end of the second tool includes a tapered portion is aligned with the female socket.

13.-14. (canceled)

14. The tool assembly of claim 13 wherein the male driver includes a plurality of flats adapted to drivingly engage a socket formed in the second fastener.

15. The tool assembly of claim 10 wherein the first tool has a first portion including a substantially cylindrical outer surface and a second portion including a larger substantially cylindrical surface.

16. The tool assembly of claim 10 wherein the bore extends through the first tool in communication with the drive recess.

17. The tool assembly of claim 10 further including a pin interconnecting the first and second tools.

18. The tool assembly of claim 10 further including a weld interconnecting the first and second tools.

19. The tool assembly of claim 10 wherein the second tool includes a substantially cylindrical outer surface sized to translate within the bore prior to fixing the second tool for rotation with the first tool.

20. The tool assembly of claim 10 wherein the socket of the first tool is shaped to drivingly engage a hexagonally shaped head of the first fastener and wherein the driving portion of the second tool includes a female socket including a hexalobular shape.
